(19) United States
(12) Patent Application Publication
(10) Pub. No.: US 2014/0285999 A1
(43) Pub. Date: Sep. 25, 2014

(54) COMBINATION SPEAKER AND LIGHT SOURCE POWERED USING LIGHT SOCKET

(71) Applicants: Michael Edward Smith Luna, San Jose, CA (US); Scott Fullam, Palo Alto, CA (US); Patrick Alan Narron, Boulder Creek, CA (US); Chris Merrill, San Francisco, CA (US); Derek Boyd Barrentine, Gilroy, CA (US); Sankalita Saha, Union City, CA (US); Jeremiah Robison, San Francisco, CA (US)

(72) Inventors: Michael Edward Smith Luna, San Jose, CA (US); Scott Fullam, Palo Alto, CA (US); Patrick Alan Narron, Boulder Creek, CA (US); Chris Merrill, San Francisco, CA (US); Derek Boyd Barrentine, Gilroy, CA (US); Sankalita Saha, Union City, CA (US); Jeremiah Robison, San Francisco, CA (US)

(73) Assignee: AliphCom, San Francisco, CA (US)

(21) Appl. No.: 14/210,201

(22) Filed: Mar. 13, 2014

Related U.S. Application Data
(60) Provisional application No. 61/786,179, filed on Mar. 14, 2013.

(51) Int. Cl. H04R 1/02

(52) U.S. Cl. CPC H04R 1/028
USPC 362/95

(57) ABSTRACT

Techniques associated with a combination speaker and light source powered using a light socket are described, including a housing comprising a plate coupled to a substantially hemispherical enclosure, a platform configured to couple a light source to a terminal configured to receive a light control signal, the light control signal configured to modify a light characteristic, a speaker coupled to the housing and configured to project audio in a direction, a light socket connector coupled to the housing and configured to provide power to the speaker and the light source when the light socket connector is coupled with a light socket, an acoustic sensor disposed on a surface of the housing, and a light sensor located within the housing, the light sensor facing away from the light source.

### CROSS-REFERENCE TO RELATED APPLICATIONS

This application claims the benefit of U.S. Provisional Patent Application No. 61/786,179 (Attorney Docket No. ALI-270P), filed Mar. 14, 2013, which is incorporated by reference herein in its entirety for all purposes.

### FIELD

The present invention relates generally to electrical and electronic hardware, electromechanical and computing devices. More specifically, techniques related to a combination speaker and light source powered using a light socket are described.

### BACKGROUND

Conventional devices for lighting typically do not provide audio playback capabilities, and conventional devices for audio playback (i.e., speakers) typically do not provide light. Although there are conventional speakers equipped with light features for decoration or as part of a user interface, such conventional speakers are typically not configured to provide ambient lighting or the light an environment. Also, conventional speakers typically are not configured to be installed into or powered using a light socket.

Thus, what is needed is a solution for a combination speaker and light source powered using a light socket without the limitations of conventional techniques.

### BRIEF DESCRIPTION OF THE DRAWINGS

Various embodiments or examples (“examples”) are disclosed in the following detailed description and the accompanying drawings:

FIGS. 1A-1B illustrate exemplary combination speaker and light source devices powered using a light socket;

FIG. 2 illustrates an exemplary architecture for a combination speaker and light source device;

FIGS. 3A-3B illustrate side-views of exemplary combination speaker and light source devices;

FIG. 3C illustrates a top-view of an exemplary combination speaker and light source device;

FIG. 4 illustrates an exemplary computing platform disposed in or associated with a combination speaker and light source device; and

FIGS. 5A-5B illustrate exemplary flows for a combination speaker and light source device.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a device, and a method associated with a wearable device structure with enhanced detection by motion sensor. In some embodiments, motion may be detected using an accelerometer that responds to an applied force and produces an output signal representative of the acceleration (and hence in some cases a velocity or displacement) produced by the force. Embodiments may be used to couple or secure a wearable device onto a body part. Techniques described are directed to systems, apparatuses, devices, and methods for using accelerometers, or other devices capable of detecting motion, to detect the motion of an element or part of an overall system. In some examples, the described techniques may be used to accurately and reliably detect the motion of a part of the human body or an element of another complex system. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

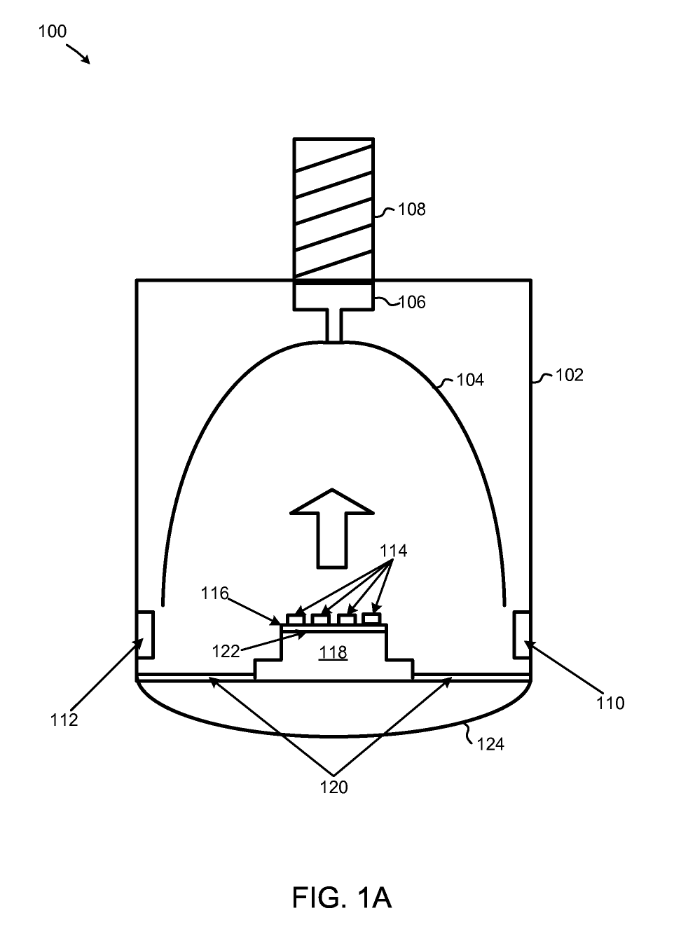

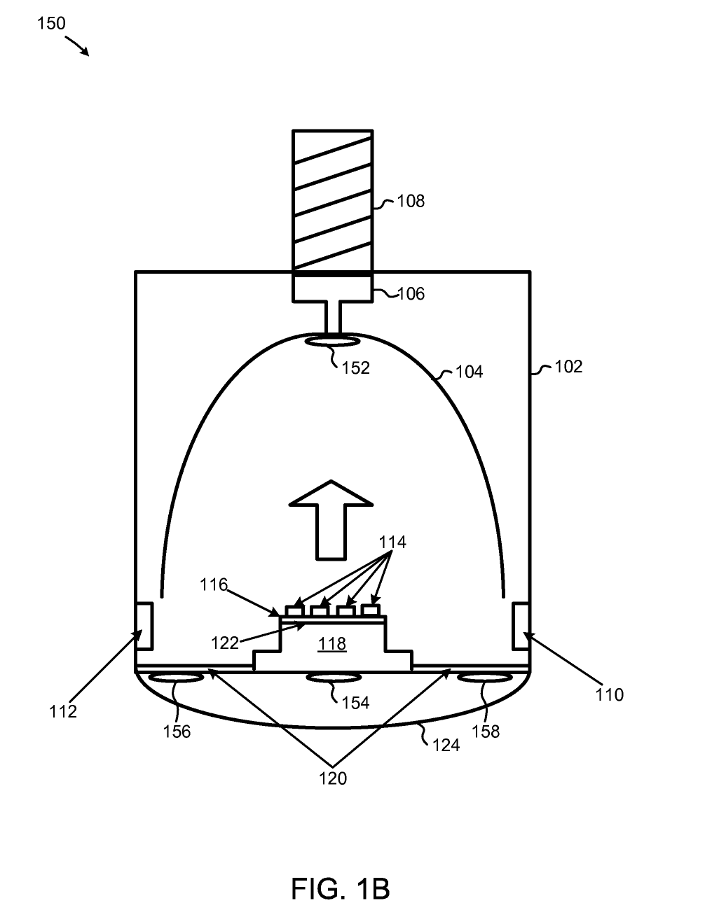

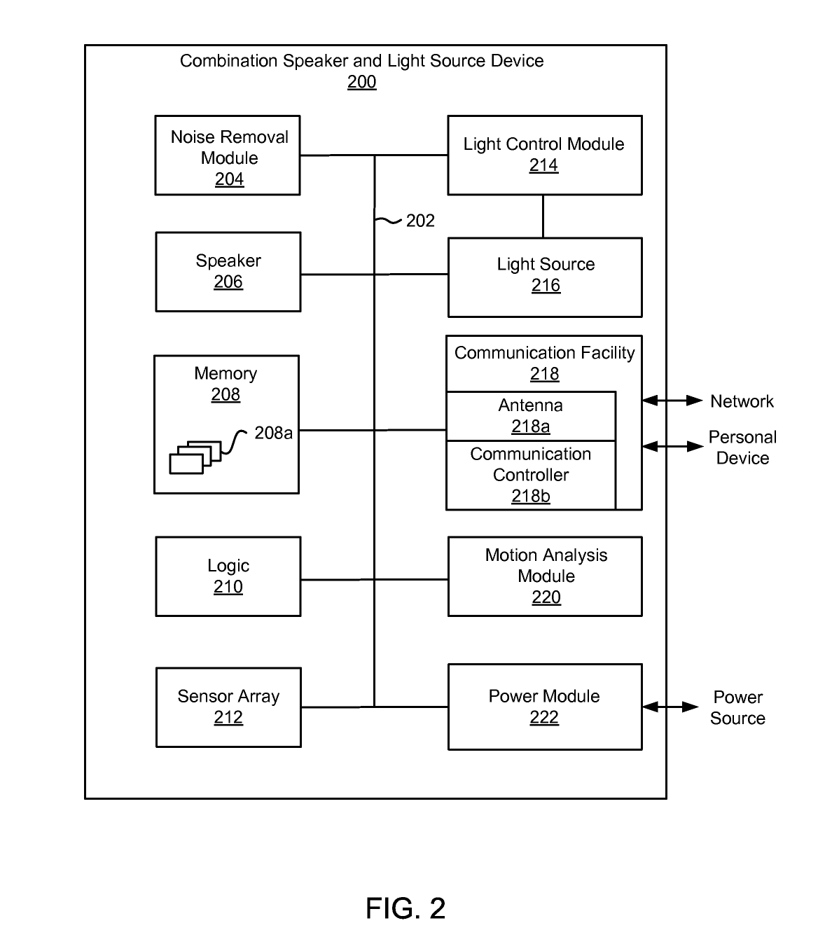

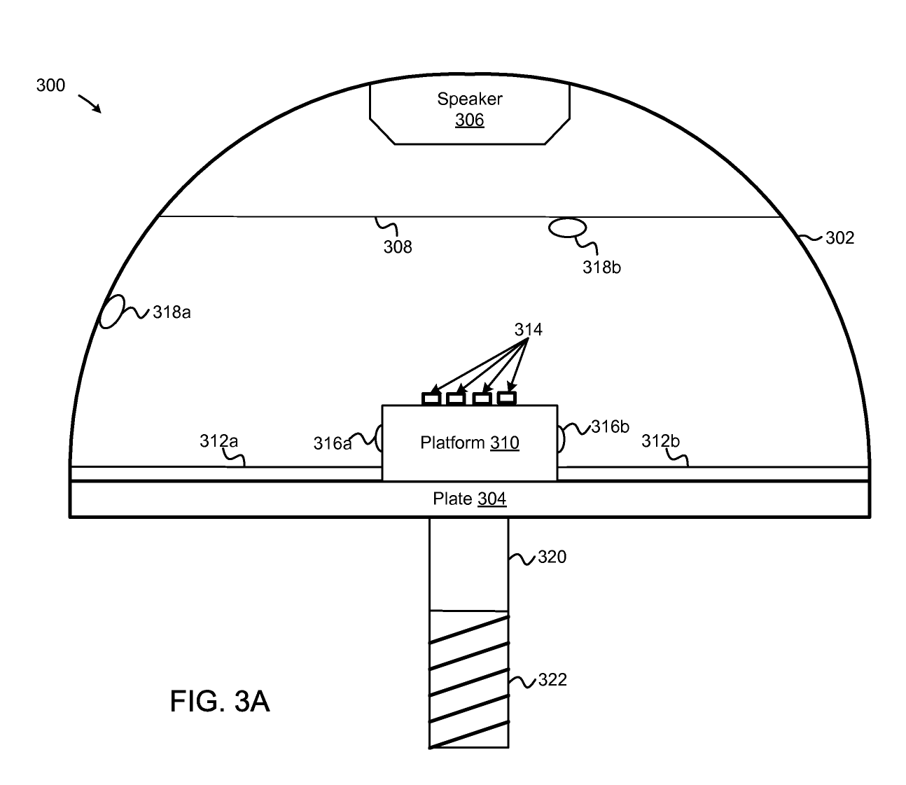

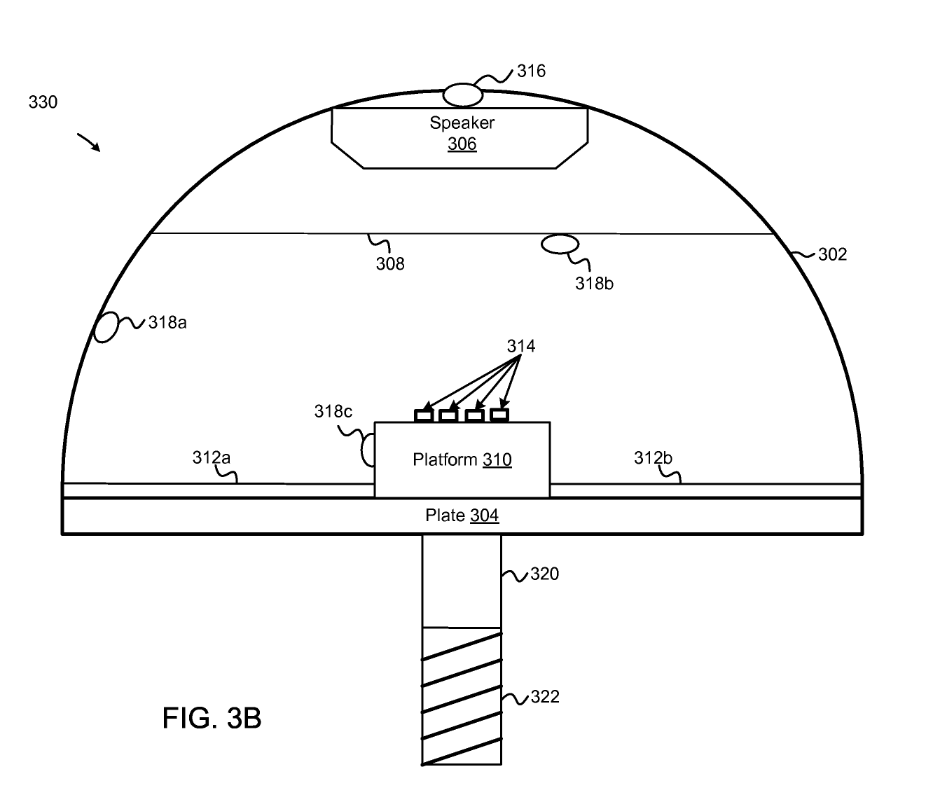

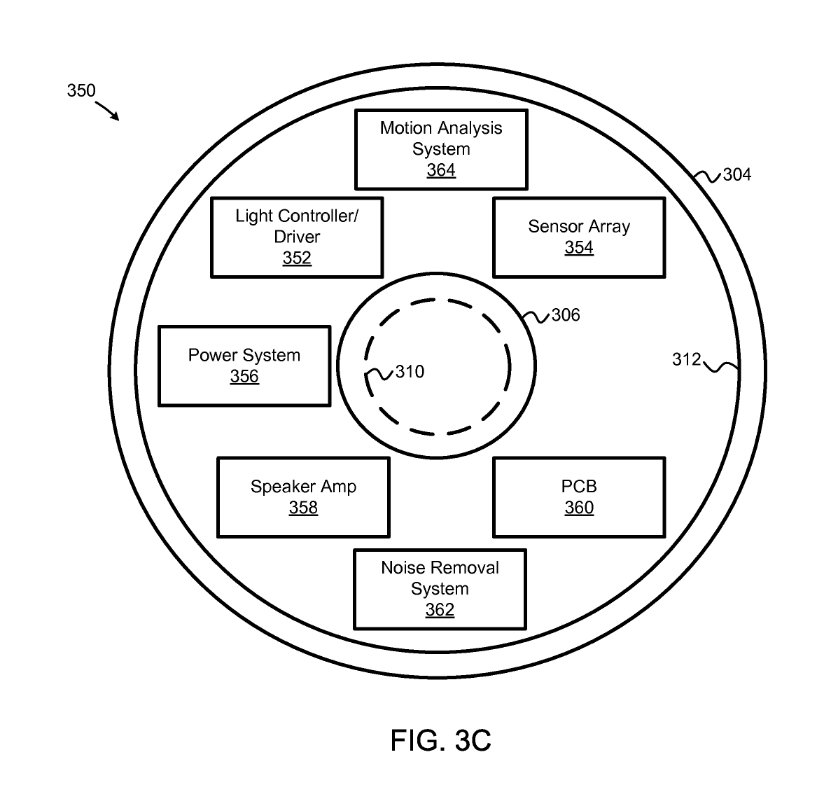

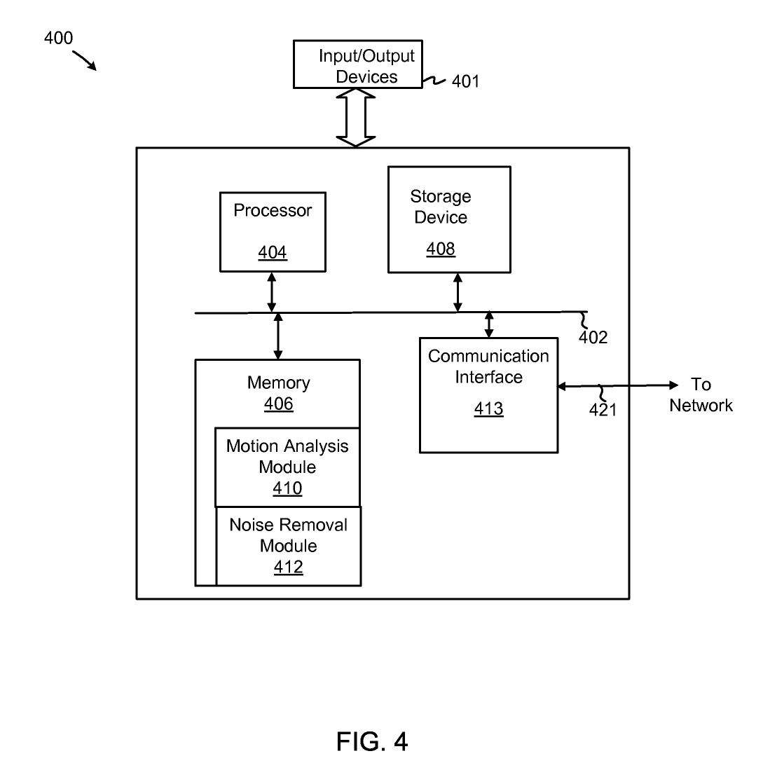

FIGS. 1A-1B illustrate exemplary combination speaker and light source devices powered using a light socket. Here, device 100 includes housing 102, parabolic reflector 104, positioning mechanism 106, light socket connector 108, passive radiators 110-112, light source 114, circuit board (PCB) 116, speaker 118, frontplate 120, backplate 122 and optical diffuser 124. In some examples, device 100 may be implemented as a combination speaker and light source (hereinafter “speaker-light device”), including a controllable light source (i.e., light source 114) and a speaker system (i.e., speaker 118). In some examples, light source 114 may be configured to provide adjustable and controllable light, including an on or off state, varying colors, brightness, and irradiance patterns, without limitation. In some examples, light source 114 may be controlled using a controller or control interface (not shown) in data communication with light source 114 (i.e., using a communication facility implemented on PCB 116) using a wired or wireless network (e.g., power line standards (e.g., G.hn, HomePlugAV, HomePlugAV2, IEEE1901, or the like), Ethernet, WiFi (e.g., 802.11 a/b/g/n/ac, or the like), Bluetooth®, or the like). In some examples, light source 114 may be implemented using one or more light emitting diodes (LEDs) coupled to PCB 116. For example, light source 114 may include different colored LEDs (e.g., red, green, blue, white, and the like), which may be used individually or in combination to produce a broad spectrum of colored light, as well as various hues. Each LED, or set of LEDs, may be controlled independently to generate various patterns. In other examples, light source 114 may be implemented using a different type of light source (e.g., incandescent, light emitting electrochemical cells, halogen, compact fluorescent, or the like). In some examples, PCB 116 may be bonded or otherwise mounted to backplate 122, which may be coupled to a driver (not shown) for speaker 118, to provide a heatsink for light source 114. In some examples, PCB 116 may provide a control signal to light source 114, for example, to turn light source 114 on and off, or control various characteristics associated with light source 114 (e.g., amount, amplitude, brightness, color, quality, of light, or the like). In some examples, PCB 116 may be configured to implement one or more control modules or systems (e.g., motion analysis module 220 and noise removal module 204 in FIG. 2, motion analysis system 364 and noise removal system 362 in FIG. 3C, motion analysis module 410 and noise removal module 412 in FIG. 4, and the like), as described herein, to generate a control signal configured to change a light characteristic associated with light output by light source 114. In some examples, light source 114 may direct light towards parabolic reflector 104, as shown. In some examples, parabolic reflector 104 may be configured to direct light from light source 114 towards a front of housing 102 (i.e., towards frontplate 120 and optical diffuser 124), which may be transparent. In some examples, parabolic reflector 104 may be movable (e.g., turned, rotated, shifted, repositioned, or the like) using positioning mechanism 106, either manually or electronically, for example, using a remote control in data communication with circuitry implemented in positioning mechanism 106. For example, parabolic reflector 104 may be moved to change an output light irradiation pattern. In some examples, parabolic reflector 104 may be acoustically transparent such that additional volume within housing 102 (i.e., around and outside of parabolic reflector 104) may be available for acoustic use with a passive radiation system (e.g., including passive radiators 110-112, and the like).

In some examples, light socket connector 108 may be configured to be coupled with a light socket (e.g., standard Edison screw base, as shown, bayonet mount, bi-post, bi-pin, or the like) for powering (i.e., electrically) device 100. In some examples, light socket connector 108 may be coupled to housing 102 on a side opposite to optical diffuser 124 and/or speaker 118. In some examples, housing 102 may be configured to house one or more of parabolic reflector 104, positioning mechanism 106, passive radiators 110-112, light source 114, PCB 116, speaker 118 and frontplate 120. Electronics (not shown) configured to support control, audio playback, light output, and other aspects of device 100, may be mounted anywhere inside or outside of housing 102. In some examples, light socket connector 108 may be configured to receive power from a standard light bulb or power connector socket (e.g., E26 or E27 screw style, T12 or GU4 pins style, or the like), using either or both AC and DC power. In some examples, device 100 also may be implemented with an Ethernet connection.

In some examples, speaker 118 may be suspended in the center of frontplate 120, which may be sealed. In some examples, frontplate 120 may be transparent and mounted or otherwise coupled with one or more passive radiators. In some examples, speaker 118 may be configured to be controlled (e.g., to play audio, to tune volume, or the like) remotely using a controller (not shown) in data communication with speaker 118 using a wired or wireless network. In some examples, housing 102 may be acoustically sealed to provide a resonant cavity when combined with passive radiators 110-112 (or other passive radiators, for example, disposed on frontplate 120 (not shown). In other examples, radiators 110-112 may be disposed on a different internal surface of housing 102 than shown. The combination of an acoustically sealed housing 102 with one or more passive radiators (e.g., passive radiators 110-112) improves low frequency audio signal reproduction, while optical diffuser 124 may be acoustically transparent, thus sound from speaker 118 may be projected out of a front end of housing 102 through optical diffuser 124. In some examples, optical diffuser 124 may be configured to be waterproof (e.g., using a seal, chemical waterproofing material, and the like). In some examples, optical diffuser 124 may be configured to spread light (i.e., reflected using parabolic reflector 104) evenly as light exits housing 102 through a transparent frontplate 120. In some examples, optical diffuser 124 may be configured to be acoustically transparent in a frequency selective manner (i.e., acoustically transparent, or designed to not impede sound waves, in certain selected frequencies), functioning as an additional acoustic chamber volume (i.e., forming an acoustic chamber volume with a front end of housing 102, as defined by frontplate 120, as part of a passive radiator system including housing 102, radiators 110-112, and other components of device 100). In other examples, the quantity, type, function, structure, and configuration of the elements shown may be varied and are not limited to the examples provided.

In FIG. 1B, speaker light device 150 also may include housing 102, parabolic reflector 104, positioning mechanism 106, light socket connector 108, passive radiators 110-112, light source 114, circuit board (PCB) 116, speaker 118, frontplate 120, backplate 122 and optical diffuser 124, as well as sensors 152-158. In some examples, sensor 154 may comprise an optical or light sensor (e.g., infrared (IR), LED, luminosity, photoelectric, photodetector, photodiode, electro-optical, optical position sensor, fiber optic, and the like), and may be disposed, placed, coupled, or otherwise located, on a side of speaker 118 or frontplate 120 opposite to light source 114, such that sensor 154 is shielded from light from light source 114 being dispersed by parabolic reflector 104, and said light will not interfere with the ability of sensor 154 to detect light from a source other than light source 114. In some examples, sensors 156-158 may comprise one or more acoustic sensors (e.g., microphone, acoustic vibration sensor, skin-surface microphone, microelectromechanical systems (MEMS), and the like), and may be disposed, placed, coupled, or otherwise located, on a side of housing 102 or frontplate 120, away from a direction of audio output by speaker 118 in order to minimize any interference by speaker 118 with the ability of sensors 156-158 to detect ambient sounds, speech, or acoustic vibrations other than said audio output by speaker 118. In some examples, one or more of sensors 152-158 may comprise other types of sensors (e.g., chemical (e.g., CO₂/O₂ and the like), temperature, motion, and the like). In other examples, the quantity, type, function, structure, and configuration of the elements shown may be varied and are not limited to the examples provided.

FIG. 2 illustrates an exemplary architecture for a combination speaker and light source device. Here, combination speaker and light source device (i.e., speaker-light device) 200 includes bus 202, noise removal module 204, speaker 206, memory 208, logic 210, sensor array 212, light control module 214, light source 216, communication facility 218, motion analysis module 220, and power module 222. Like-numbered and named elements may describe the same or substantially similar elements as those shown in other descriptions. In some examples, sensor array 212 may include one or more of a motion sensor (e.g., accelerometer, gyroscopic sensors, optical motion sensors (e.g., laser or LED motion detectors, such as used in optical mice), magnet-based motion sensors (e.g., detecting magnetic fields, or changes thereof, to detect motion), electromagnetic-based sensors, MEMS, and the like), a chemical sensor (e.g., carbon dioxide (CO₂), oxygen (O₂), carbon monoxide (CO), airborne chemical, toxin, and the like), a temperature sensor (e.g., thermometer, temperature gauge, IR thermometer, resistance thermometer, heat flux sensor, and the like), humidity sensor, passive IR sensor, ultrasonic sensor, proximity sensor, pressure sensor, light sensors and acoustic sensors, as described herein, and the like. In some examples, noise removal module 204 may be configured to remove audio output from speaker 206 from sounds (i.e., acoustics) being captured using an acoustic sensor in sensor array 212. For example, noise removal module 204 may be configured to subtract the output from speaker 206 from the acoustic input to sensor array 212 to determine ambient sound in a room or other environment surrounding speaker-light device 200. In other examples, noise removal module 204 may be configured to remove a different set of known acoustic noise (e.g., permanent ambient noise, frequency-selected noise, ambient noise to isolate speech or a speech command, and the like). In some examples, motion analysis module 220 may be configured to generate movement data using sensor data captured by sensor array 212, the movement data indicating an identity (i.e., by a motion signature or motion fingerprint) of, or activity or gesture (e.g., fingerpoint, arm wave, hand wave, thumbs up, and the like) being performed by, a person in a room or other environment surrounding speaker-light device 200. Techniques associated with determining an activity using sensor data are described in co-pending U.S. patent application Ser. No. 13/433,204 (Attorney Docket No. ALI-013CIP1), filed Mar. 28, 2012, and techniques associated with determining, and identifying a person with, a motion fingerprint or signature are described in co-pending U.S. patent application Ser. No. 13/181,498 (Attorney Docket No. ALI-018), filed Jul. 12, 2011, all of which are incorporated by reference herein in their entirety for all purposes. In some examples, motion analysis module 220 also may be configured to determine a level, amount, or type of motion in a room or environment, and cross-reference such information with data generated by communication facility 218 indicating a number of personal devices, and thus a number of people, in said room or environment, to determine a nature of a setting (e.g., social, private, a single person using a single media device, two or more people using separate media devices, a single person using multiple media devices, a set of people using a single media device, a single person resting or sleeping, an adult and a baby resting or sleeping, and the like). In some examples, said activity or gesture may cause speaker-light device 200, for example, based on profile data 208a stored in memory 208, to change or modify a light characteristic (e.g., color, brightness, hue, pattern, amplitude, frequency, and the like) associated with light output by light source 216 and/or an audio characteristic (e.g., volume, perceived loudness, amplitude, sound pressure, noise reduction, frequency selection, normalization, and the like) associated with audio output by speaker 206. In some examples, light characteristics may be modified using light control module 214, which may include a light controller and a driver. In other examples, profile data 208a may associate a light characteristic with an audio characteristic, thus causing light control module 214 to direct a control signal (i.e., light control signal) to light source 216 to modify a light characteristic associated with light being output by light source 216 in response to audio being output by speaker 206, thus correlating a light output with an audio output (e.g., flashing lights or laser light patterns being output in coordination with loud, techno, or other fast tempo, music with hard beats; dim, warm, steady light being output in coordination with slow, soft, instrumental music; and the like). In some examples, speaker 206 may be implemented as a speaker system, including one or more of a woofer, a tweeter, other drivers, a passive or hybrid radiation system, reflex port, and the like. In other examples, the quantity, type, function, structure, and configuration of the elements shown may be varied and are not limited to the examples provided.

In some examples, profile data 208a may comprise activity-related profiles indicating optimal lighting and acoustic output for an activity (e.g., warm, yellow light and/or soft background music for an evening social setting; low, yellow light and/or white noise for resting or sleeping; bright, blue-white light with no music or sounds for working or studying during the day). In some examples, profile data 208a also may comprise identity-related profiles for one or more users, the identity-related profiles including preference data indicating a user's preferences for light characteristics and audio characteristics in a room or other environment surrounding speaker-light device 200. Such preference data may be uploaded or saved to speaker-light device 200, for example, from a personal device (e.g., wearable device, mobile device, portable device, or other device attributable to a user or owner) using communication facility 218, or it may be learned by speaker-light device 200 over a period of time through manual manipulation by a user identified using motion analysis module 220 (e.g., gesture command, motion fingerprint, or the like), communication facility 218 (i.e., identity data received from a personal device), or the like. In some examples, a personal device may be configured to implement an application configured to provide an interface for inputting, uploading, or otherwise indicating, a user's or owner's lighting and audio preferences.

In some examples, communication facility 218 may include antenna 218a and communication controller 218b, and may be implemented as an intelligent communication facility, techniques associated with which are described in co-pending U.S. patent application Ser. No. 13/831,698 (Attorney Docket No. ALI-191CIP1), filed Mar. 15, 2013, which is incorporated by reference herein in its entirety for all purposes. As used herein, “facility” refers to any, some, or all of the features and structures that are used to implement a given set of functions. In some examples, communication controller 218b may include one or both of a short-range communication controller (e.g., Bluetooth®, NFC, ultra wideband, and the like) and longer-range communication controller (e.g., satellite, mobile broadband, GPS, WiFi, and the like). In some examples, communication facility 218 may be configured to ping, or otherwise send a message or query to, a network or personal device detected using antenna 218a, for example, to obtain preference data or other data associated with a light characteristic or audio characteristic, as described herein. In some examples, antenna 218a may be implemented as a receiver, transmitter, or transceiver, configured to detect and generate radio waves, for example, to and from electrical signals. In some examples, antenna 218a may be configured to detect radio signals across a broad spectrum, including licensed and unlicensed bands. In some examples, communication facility may include other integrated circuitry (not shown) for enabling advanced communication capabilities (e.g., Bluetooth® low energy system on chip (SoC), and the like).

In some examples, logic 210 may be implemented as firmware or application software that is installed in a memory (e.g., memory 208, memory 406 in FIG. 4, or the like) and executed by a processor (e.g., processor 404 in FIG. 4). Included in logic 210 may be program instructions or code (e.g., source, object, binary executables, or others) that, when initiated, called, or instantiated, perform various functions. In some examples, logic 210 may provide control functions and signals to other components of speaker-light device 200, including to speaker 206, light control module 214, communication facility 218, sensor array 212, or other components. In some examples, one or more of the components of speaker-light device 200, as described herein, may be connected and implemented using a PCB (e.g, PCB 116 from FIGS. 1A-1B, as described herein). In some examples, power module 222 may include a power converter, a transformer, and other electrical components for supplying power to other elements of speaker-light device 200. In some examples, power module 222 may be coupled to a light socket connector (e.g., light socket connector 108 in FIGS. 1A-1B, light socket connector 322 in FIGS. 3A-3B, and the like) to retrieve electrical power from a power source. In other examples, the quantity, type, function, structure, and configuration of the elements shown may be varied and are not limited to the examples provided.

FIGS. 3A-3B illustrate side-views of exemplary combination speaker and light source devices. Here, speaker-light device 300 includes enclosure 302 and plate 304 forming a housing, speaker 306, speaker enclosure 308, platform 310, light source 314, electronics 312a-312b, light sensors 316a-316b, acoustic sensors 318a-318b, extension structure 320 and light socket connector 322. Like-numbered and named elements may describe the same or substantially similar elements as those shown in other descriptions. In some examples, platform 310 may be configured to couple light source 314 to plate 304. In other examples, platform 310 may be configured to couple light source 314 to a different part of a housing (i.e., enclosure 302). In some examples, platform 310 may comprise a terminal configured to receive, or be coupled to, light source 314, and to provide control signals to light source 314 (i.e., light source 314 may be plugged into said terminal). In some examples, a terminal also may be coupled to a light controller (e.g., light control module 214 in FIG. 2, light controller/driver 352 in FIG. 3C, or the like), the terminal configured to receive a control signal (i.e., a light control signal) configured to modify a light characteristic. In some examples, speaker enclosure 308 may be disposed or located between speaker 306 and light source 314. In some examples, speaker enclosure 308 may be formed using a clear material allowing light from light source 314 to pass through. In some examples, speaker enclosure 308 may be formed using an acoustically opaque material such that audio output from speaker 306 does not travel through speaker enclosure 308, thus shielding acoustic sensors 318a-318b from said audio output. In other examples, speaker enclosure 308 may be formed using an acoustically transparent material, and the acoustics captured by acoustic sensors 318a-318b may be later processed by a noise removal system (e.g., noise removal module 204 in FIG. 2, noise removal system 362 in FIG. 3C, or the like), as described herein, to remove or subtract audio output from speaker 306 to derive data attributable to ambient sounds not created by speaker-light device 300. In still other examples, acoustic sensors 318a-318b may be configured to face away from speaker 306, for example at an angle, in order to minimize the amount of audio output from speaker 306 being captured by acoustic sensors 318a-318b. In some examples, light sensors 316a-316b may be located on platform 310 underneath, or otherwise facing away from, light source 314, to minimize the amount of light from light source 314 being captured by light sensors 316a-316b. In other examples, light sensors and acoustic sensors may be implemented in speaker-light device 300 differently, such as shown in FIG. 3B, and described below.

In some examples, enclosure 302 may be hemispherical or substantially hemispherical in shape. In some examples, enclosure 302 may be partially opaque, thus allowing light from light source 314 to be directed out of enclosure 302 through a portion that is not opaque (e.g., translucent or transparent). In other examples, enclosure 302 may be partially or wholly translucent and/or transparent.

In some examples, platform 310 and electronic components 312a-312b may be coupled to plate 304. In some examples, platform 310 also may be coupled to light source 314, and may include a heatsink for light source 314. In some examples, extension structure 320 may be included to couple plate 304 to light socket connector 322, where speaker-light device 300 is configured to be plugged, inserted, or otherwise coupled to a recessed light or power connector socket. In some examples, electronics 312a-312b may include a motion analysis system, a power system, a speaker amplifier, a noise removal system, a PCB, and the like, as described herein in FIG. 3C.

In some examples, one or more passive radiators (not shown) may be implemented within enclosure 302, either within an acoustically opaque speaker enclosure 308 or to both sides of an acoustically transparent speaker enclosure 308, to form a passive radiation system for speaker 306. In other examples, the quantity, type, function, structure, and configuration of the elements shown may be varied and are not limited to the examples provided.

FIG. 3B illustrates a side-view of another exemplary speaker-light device. Here, speaker-light device 330 includes light sensor 316 and acoustic sensors 318a-318c, among other components described above. Like-numbered and named elements may describe the same or substantially similar elements as those shown in other descriptions. In some examples, light sensors 316a-316b (e.g., infrared, LED, or the like, as described herein) may be disposed or located on a side of speaker 306 facing away from light source 314, speaker 306 thus shielding light sensor 316 from detecting light output from light source 314. In other examples, the quantity, type, function, structure, and configuration of the elements shown may be varied and are not limited to the examples provided.

FIG. 3C illustrates a top-view of an exemplary combination speaker and light source device. Here, speaker-light device 350 includes housing 304, speaker 306, platform 310 being hidden by speaker 306, and electronics 312, including light controller/driver 352, sensor array 354, power system 356, speaker amplifier 358, PCB 360, noise removal system 362, and motion analysis system 364. Like-numbered and named elements may describe the same or substantially similar elements as those shown in other descriptions. In some examples, housing 304 may include a hemispherical enclosure coupled to a plate as described herein. In other examples, housing 304 may be formed in a different shape than shown and described herein (e.g., cube, rectangular box, pill-shape, ovoid, lightbulb-shaped, and the like). In some examples, light controller/driver 352 may be configured to provide control signals to a light source (e.g., light source 114 in FIGS. 1A-1B, light source 216 in FIG. 2, light source 314 in FIGS. 3A-3B, and the like) to modify a characteristic of light being output (e.g., dim, brighten, change color, change hue, turn on, turn off, start/stop or change a light pattern, and the like). In some examples, power system 356 may include circuitry configured to operate a power module (e.g., power module 222 in FIG. 2, and the like) for accessing power from a power source, for example, using a light connector socket, as described herein. In some examples, sensor array 354 may include various sensors, as described herein, and may be configured to provide sensor data to motion analysis system 364 and noise removal system 362 for further processing, as described herein. In some examples, motion analysis system may include circuitry configured to operate a motion analysis module (e.g., motion analysis module 220 in FIG. 2, or the like), as described herein. In some examples, noise removal system 362 may include circuitry configured to operate a noise removal module (e.g., noise removal module 204 in FIG. 2, or the like), as described herein. In other examples, the quantity, type, function, structure, and configuration of the elements shown may be varied and are not limited to the examples provided.

FIG. 4 illustrates an exemplary computing platform disposed in a combinations speaker and light source device in accordance with various embodiments. Like-numbered and named elements may describe the same or substantially similar elements as those shown in other descriptions. In some examples, computing platform 400 may be used to implement computer programs, applications, methods, processes, algorithms, or other software to perform the above-described techniques. Computing platform 400 includes a bus 402 or other communication mechanism for communicating information, which interconnects subsystems and devices, such as processor 404, system memory 406 (e.g., RAM, etc.), storage device 408 (e.g., ROM, etc.), a communication interface 413 (e.g., an Ethernet or wireless controller, a Bluetooth® controller, etc.) to facilitate communications via a port on communication link 421 to communicate, for example, with a computing device, including mobile computing and/or communication devices with processors. Processor 404 can be implemented with one or more central processing units (“CPUs”), such as those manufactured by Intel® Corporation, CircuitCo Printed Circuit Board Solutions, or one or more virtual processors, as well as any combination of CPUs and virtual processors. Computing platform 400 exchanges data representing inputs and outputs via input-and-output devices 401, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 400 performs specific operations by processor 404 executing one or more sequences of one or more instructions stored in system memory 406, and computing platform 400 can be implemented in a client-server arrangement, peer-to-peer arrangement, or as any mobile computing device, including smart phones and the like. Such instructions or data may be read into system memory 406 from another non-transitory computer readable medium, such as storage device 408. In some examples, hard-wired circuitry may be used in place of or in combination with software instructions for implementation. Instructions may be embedded in software or firmware. The term “non-transitory computer readable medium” refers to any tangible medium that participates in providing instructions to processor 404 for execution. Such a medium may take many forms, including but not limited to, non-volatile media and volatile media. Non-volatile media includes, for example, optical or magnetic disks and the like. Volatile media includes dynamic memory, such as system memory 406.

Common forms of non-transitory computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 402 for transmitting a computer data signal.

In some examples, execution of the sequences of instructions may be performed by computing platform 400. According to some examples, computing platform 400 can be coupled by communication link 421 (e.g., a wired network, such as LAN, PSTN, or any wireless network) to any other processor to perform the sequence of instructions in coordination with (or asynchronous to) one another. Computing platform 400 may transmit and receive messages, data, and instructions, including program code (e.g., application code) through communication link 421 and communication interface 413. Received program code may be executed by processor 404 as it is received, and/or stored in memory 406 or other non-volatile storage for later execution.

In the example shown, system memory 406 can include various modules that include executable instructions to implement functionalities described herein. In the example shown, system memory 406 includes a motion analysis module 410 configured to analyze sensor data and generate movement data associated with detected movement, as described herein. Also shown is noise removal module 412 configured to remove or subtract a known acoustic signal from acoustic sensor data captured by an acoustic sensor, as described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the structures and techniques described herein can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, speaker-light devices 100, 150, 200, 300, and 350, including one or more components, can be implemented in one or more computing devices that include one or more circuits. Thus, at least one of the elements in FIGS. 1-3C can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

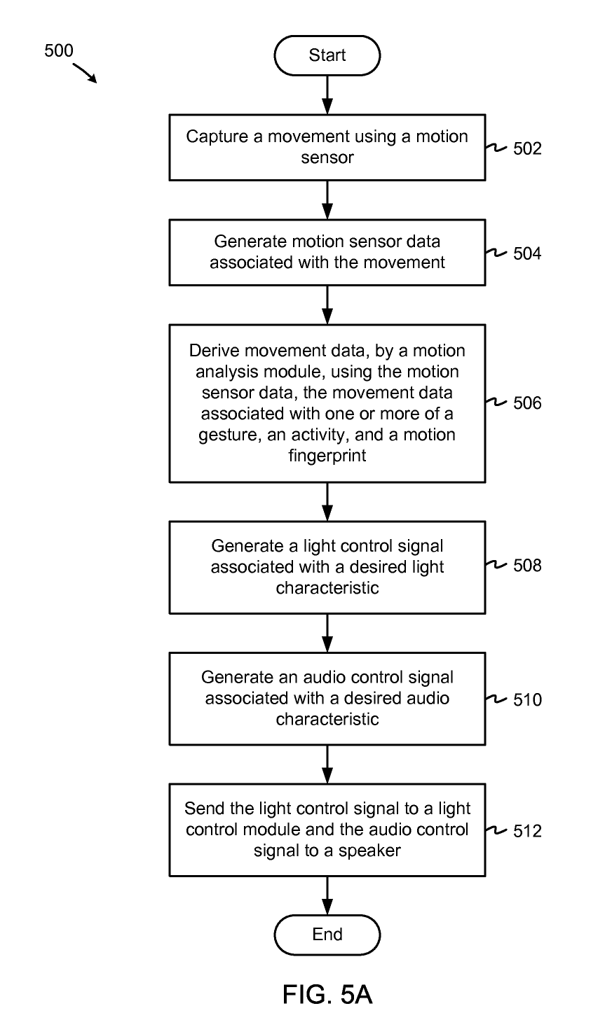

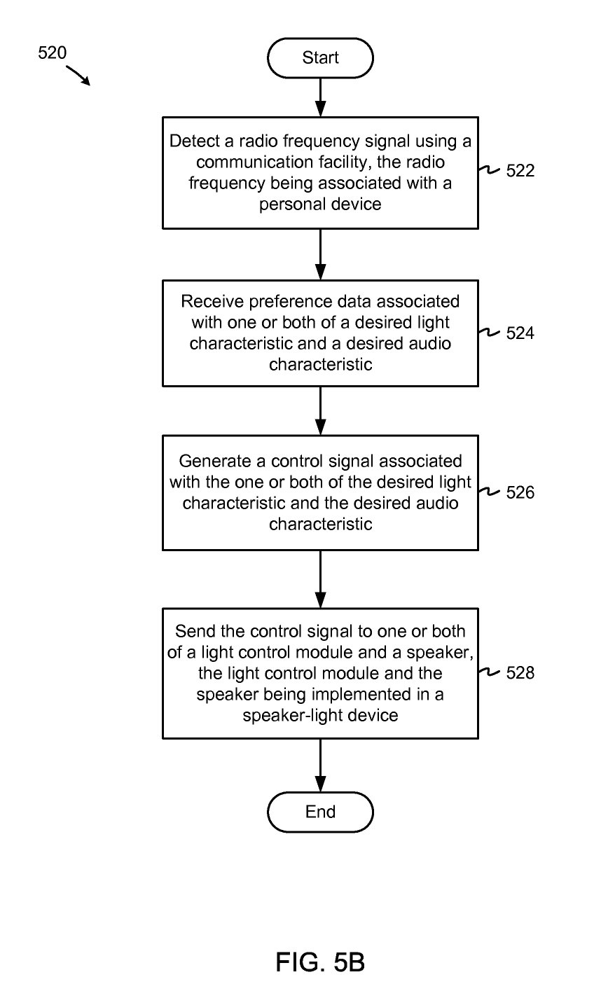

FIGS. 5A-5B illustrate exemplary flows for a combination speaker and light source device. Here, process 500 begins with capturing a movement using a motion sensor (502), for example, implemented in a speaker-light device, as described herein. In some examples, said movement may include an activity, a gesture (i.e., hand or arm gesture), or motion fingerprint (e.g., gait, arm swing, or the like). Said motion sensor may generate motion sensor data associated with the movement in response to said captured movement (504). Then movement data may be derived by a motion analysis module using the motion sensor data, the movement data associated with one or more of a gesture, an activity, and a motion fingerprint (506). In some examples, a motion analysis module may be implemented in said speaker-light device. In some examples, such movement data may be cross-referenced or correlated with preference data gathered from a personal device, for example, using process 520 in FIG. 5B, as described herein, to determine one or more desired light characteristics and/or audio characteristics. In some examples, a motion analysis module may be configured to determine a desired light characteristic and/or audio characteristic. In some examples, a motion analysis module may be configured to perform the cross-reference of movement data with preference data. In other examples, a motion analysis module may provide movement data, or desired light and/or audio characteristic data associated with movement data, to another module to perform the cross-reference of movement data with preference data to determine or modify desired light and/or audio characteristic data. Once desired light characteristic data is determined (and in some cases, confirmed or modified according to preference data), a light control signal associated with said desired light characteristic may be generated (508), the light control signal configured to modify a light output (e.g., brightness, color, hue, pattern, amplitude, frequency, on, off, or the like) by a light source, as described herein. In other examples, a determination may be made to keep light characteristics as they are (i.e., current light characteristics match determined desired light characteristics). Once desired audio characteristic data is determined (and in some cases, confirmed or modified according to preference data), an audio control signal associated with said desired audio characteristic may be generated (510), the audio control signal configured to modify an audio output (e.g., volume, perceived loudness, amplitude, sound pressure, noise reduction, frequency selection, normalization, and the like) by a speaker, as described herein. The light control signal may be sent to a light control module, and the audio control signal sent to a speaker (512), the light control module and the speaker being implemented in a speaker-light device. In other examples, the above-described process may be varied in steps, order, function, processes, or other aspects, and is not limited to those shown and described.

In FIG. 5B, process 520 begins with detecting a radio frequency signal using a communication facility (i.e., implemented in a speaker-light device, as described herein), the radio frequency being associated with a personal device (522). In some examples, a strength of a radio frequency signal may be used to determine a proximity of a personal device (i.e., wearable device, portable device, mobile device, or other device attributable to a user/owner). In some examples, a speaker-light device may be configured to ping, or otherwise send a query to, a personal device to obtain identity (i.e., identifying) data associated with a user or owner of said personal device, and said identity data may be associated with a profile stored in a memory implemented in a speaker-light device, as described herein. In some examples, a speaker-light device also may receive preference data associated with one or both of a desired light characteristic and a desired audio characteristic (524). A control signal associated with the one or both of the desired light characteristic and the desired audio characteristic may be generated (526), the control signal configured to modify a light output and/or audio output, as described herein. Once generated, the control signal may be sent to a light control module and/or a speaker, for example, being implemented in a speaker-light device (528). In other examples, the above-described process may be varied in steps, order, function, processes, or other aspects, and is not limited to those shown and described.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A system, comprising:
a housing comprising a plate coupled to an enclosure, wherein the enclosure is substantially hemispherical;
a platform configured to couple a light source to a terminal configured to receive a light control signal, the light control signal configured to modify a light characteristic;
a speaker coupled to the housing and configured to project audio in a direction;
a light socket connector coupled to the housing and configured to provide power to the speaker and the light source when the light socket connector is coupled with a light socket;
an acoustic sensor disposed on a second surface of the housing; and
a light sensor located within the housing, the light sensor facing away from the light source.

2. The system of claim 1, further comprising a speaker enclosure located between the speaker and the platform.

3. The system of claim 2, wherein the speaker enclosure is comprised of a clear material configured to allow light to pass through the speaker enclosure.

4. The system of claim 2, wherein the speaker enclosure is comprised of an acoustically opaque material.

5. The system of claim 2, wherein:
the speaker enclosure is comprised of an acoustically opaque material; and
the acoustic sensor is disposed on an opposite side of the speaker enclosure from the speaker.

6. The system of claim 2, wherein the speaker enclosure is comprised of an acoustically transparent material.

7. The system of claim 1, wherein the housing is at least partially opaque.

8. The system of claim 1, wherein the housing is at least partially translucent.

9. The system of claim 1, further comprising an extension structure configured to couple the housing to the light socket connector.

10. The system of claim 1, wherein the speaker is disposed between the platform and the light sensor, the speaker configured to prevent the light sensor from detecting a light from the light source.

11. The system of claim 1, wherein the light sensor is an infrared light sensor.

12. The system of claim 1, wherein the second surface faces at an angle away from the direction of the audio.

13. The system of claim 1, further comprising a noise removal module configured to remove the audio output by the speaker from the acoustic input being captured by the acoustic sensor.

14. The system of claim 1, wherein the platform comprises a heatsink.

15. The system of claim 1, further comprising one or more passive radiators coupled to an interior surface of the housing, the housing and the one or more passive radiators forming a passive radiation system.

16. The system of claim 1, further comprising a motion analysis module configured to generate the light control signal in response to movement captured using a motion sensor.

17. The system of claim 1, further comprising a motion analysis module configured to generate an audio control signal in response to movement captured using a motion sensor.

18. The system of claim 17, wherein the audio control signal is configured to modify an audio characteristic associated with the speaker.

19. The system of claim 1, further comprising a motion analysis module configured to derive movement data associated with a gesture, and to generate a control signal using the movement data.

20. The system of claim 1, further comprising a motion analysis module configured to derive movement data associated with an identity, and to generate a control signal using the movement data.
